(19) United States
(12) Patent Application Publication
(10) Pub. No.: US 2024/0213754 A1
(43) Pub. Date: Jun. 27, 2024

(54) ENCLOSURE FOR TELECOMMUNICATIONS CABLES

(71) Applicant: BRITISH TELECOMMUNICATIONS PUBLIC LIMITED COMPANY, LONDON (GB)

(72) Inventors: Sam BLISSETT, London (GB); Ian HUNTER, London (GB)

(21) Appl. No.: 18/574,649

(22) PCT Filed: Jun. 16, 2022
(86) PCT No.: PCT/EP2022/066471

§ 371 Date: Dec. 27, 2023

(30) Foreign Application Priority Data
Jul. 2, 2021 (GB) 2109603.7

(51) Int. Cl. H02G 15/113; G02B 6/38; H02G 15/16

(52) U.S. Cl. CPC H02G 15/113; G02B 6/3897; H02G 15/16

(57) ABSTRACT

An enclosure for a pair of interconnected telecommunications cables, each of the cables including a connector and a boot, and the enclosure including a housing for the pair of interconnected telecommunications cables; and an engagement formation configured to receive each connector and each boot of the pair of interconnected telecommunications cables and to fasten the telecommunications cables to the housing.

### PRIORITY CLAIM

The present application is a National Phase entry of PCT Application No. PCT/EP2022/066471, filed Jun. 16, 2022, which claims priority from GB Application No. 2109603.7, filed Jul. 2, 2021, each of which hereby fully incorporated herein by reference.

### TECHNICAL FIELD

The present disclosure relates to an enclosure for interconnected telecommunications cables.

### BACKGROUND

In fixed access telecommunications networks, enclosures may be provided to house and to help fasten together interconnected telecommunications cables.

However, existing enclosures may insufficiently fasten interconnected telecommunications cables, and therefore may allow the cables to flex and/or shift such that the cables wear, disconnect, and/or break.

In particular, existing enclosures may be used with cable ties so as to fasten cables to the enclosure; this imposes a burden upon a user to supply cable ties, as well as to replace them every time the cables are changed out. Furthermore, to avoid excessive movement of the interconnected telecommunications cables, a user must ensure that the cable ties are appropriately tensioned and located along the interconnected telecommunications cables.

It is an aim of the present disclosure to at least alleviate some of the aforementioned problems.

### SUMMARY

According to a first aspect of the present disclosure, there is provided: an enclosure for a pair of interconnected telecommunications cables, each of the cables comprising a connector and a boot, and the enclosure comprising: a housing for the pair of interconnected telecommunications cables; and an engagement formation configured to receive each connector and each boot of the pair of interconnected telecommunications cables and to fasten the telecommunications cables to the housing.

As used herein, the term “a pair of interconnected telecommunications cables” can connote two telecommunications cables that are communicatively interconnected with one another.

Optionally, the boot is in the form of a: strain relief boot; cable gland; cord grip; and/or cable fitting. In some embodiments, the connector provides a mechanical and a communication interconnection, and optionally also a fluid connector and/or seal. In some embodiments, the connector is in the form of a push-fit connector.

Optionally, the connector is in the form of a: Fiber Channel (FC) connector; Lucent Connector (LC); Multiple-Fiber Push-On/Pull-off (MPO); Subscriber Connector (SC); or Mechanical Transfer (MT) connector.

In some embodiments, the housing and/or the engagement formation is/are rigid. In some embodiments, the housing is configured to house, at least, each of the connectors and boots.

In some embodiments, the pair of interconnected telecommunications cables are directly interconnected and are available to be interconnected in the absence of the enclosure.

In some embodiments, the engagement formation is arranged so as to fasten the pair of telecommunications cables along at least one central axis of the housing.

In some embodiments, the engagement formation is configured to receive an entirety of the connector and boot in at least two dimensions.

Optionally, the engagement formation is symmetrical about only two, or all three, perpendicular axes.

In some embodiments, the engagement formation comprises: a boot engagement member for receiving each boot; and a connector engagement formation for receiving each connector.

In some embodiments, the boot engagement member extends in prolongation of the connector engagement formation.

In some embodiments, the boot engagement member is integrally formed with the connector engagement formation.

In some embodiments, the boot engagement member extends away from the connector engagement formation, and for example in both opposing directions.

In some embodiments, the boot engagement member extends continuously from the connector engagement formation.

In some embodiments, the boot engagement member and the connector engagement formation are aligned with one another.

In some embodiments, the engagement formation is provided as part of the housing. In some embodiments, the engagement formation is provided within, or enclosed by, the housing.

In some embodiments, the engagement member is integrally formed with the housing.

In some embodiments, the engagement formation is shaped and dimensioned so as to conform with the shapes and dimensions of each of the connectors and boots.

In some embodiments, the engagement formation comprises a channel. In some embodiments, the channel is an open channel. In this way, each telecommunications cable is readily receivable by the engagement formation, and in particular without having to thread cables. Optionally, the channel is a recess or groove. In some embodiments, the connector engagement formation and the boot engagement member are in the form of a channel, and for example the channel of the connector engagement formation is wider than that of the boot engagement member.

In some embodiments, the engagement formation comprises a surface for preventing disconnection of the pair of interconnected cables when the cables are provided in the engagement formation. In some embodiments, the surface is angled so as to prevent disconnection. In some embodiments, the surface is in the form of a narrowing of the channel away from the connector engagement member. In some embodiments the narrowing is provided as part of the boot engagement member. In some embodiments, the surface is in the form of a flange, wall, or projection. In some embodiments, the surface is formed as part of the connector engagement member and arranged to limit travel of the connectors by abutting against the connectors. In some embodiments, the surface is arranged distally to the connectors.

In some embodiments, the housing comprises a complementary lid and a base, wherein the engagement formation is formed of a first part arranged on the lid and a second part arranged on the base. In this way, the engagement formation may surround a pair of interconnected cables. In some embodiments, the housing and engagement formation are open so as to receive the interconnected cables, while interconnected, by slotting the cables into the housing and engagement formation, rather than by threading the cables thereinto.

In some embodiments, the first and the second parts are aligned on the lid and the base, such that the first and the second parts are configured both to enclose the pair of interconnected telecommunications cables.

In some embodiments, the pair of interconnected telecommunications cables each comprise a cord extending from the boot, and wherein the engagement formation is further configured to receive and to fasten the cord.

In some embodiments, the engagement formation is in the form of a friction-fit engagement and/or compression-fit engagement for the pair of interconnecting cables, and may in particular be for the boot of the cables. Optionally, the engagement formation is formed of, or lined with, a compliant material.

In some embodiments, the engagement formation extends along the entire length of the housing, such as no less than 50% of the length, and for example no less than 75% of the length.

In some embodiments, the enclosure comprises a plurality of engagement formations, thereby to fasten a plurality of pairs of interconnected telecommunications cables to the housing.

In some embodiments, at least a portion of a given engagement formation also forms at least a portion of another engagement formation that is adjacent to the given engagement formation. In some embodiments, adjacent engagement formations share a portion of their structures, and for example the structure is the connector engagement member.

In some embodiments, the plurality of engagement formations are arranged parallel to one another In some embodiments, the plurality of engagement lie in the same plane.

The disclosure includes any novel aspects described and/or illustrated herein. The disclosure also extends to methods and/or apparatus substantially as herein described and/or as illustrated with reference to the accompanying drawings. The disclosure is also provided as a computer program and/or a computer program product for carrying out any of the methods described herein and/or for embodying any of the apparatus features described herein, and a computer-readable medium storing thereon a program for carrying out any of the methods and/or for embodying any of the apparatus features described herein. Features described as being implemented in hardware may alternatively be implemented in software, and vice versa.

Any apparatus feature may also be provided as a corresponding part of a method, and vice versa. As used herein, means plus function features may alternatively be expressed in terms of their corresponding structure, for example as a suitably-programmed processor.

Any feature in one aspect of the disclosure may be applied, in any appropriate combination, to other aspects of the disclosure. Any, some and/or all features in one aspect can be applied to any, some and/or all features in any other aspect, in any appropriate combination. Particular combinations of the various features described and defined in any aspects of the disclosure can be implemented and/or supplied and/or used independently.

As used throughout, the word ‘or’ can be interpreted in the exclusive and/or inclusive sense, unless otherwise specified.

### BRIEF DESCRIPTION OF THE DRAWINGS

The disclosure extends to an enclosure as described herein and/or substantially as illustrated with reference to the accompanying drawings. The present disclosure is now described, purely by way of example, with reference to the accompanying diagrammatic drawing:

FIG. 1 is a schematic of an enclosure for interconnected telecommunication cables.

### SPECIFIC DESCRIPTION

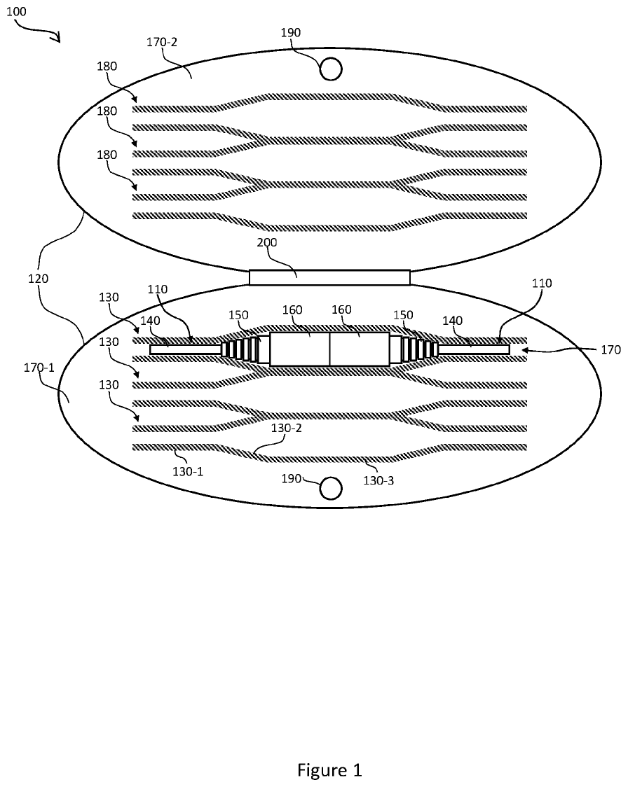

FIG. 1 schematically shows an enclosure 100 for enclosing a pair of (two) interconnected telecommunications cables 110.

In overview, the enclosure 100 comprises a housing 120, which in turn comprises an engagement formation 130.

The two interconnected telecommunications cables 110 each comprise, at their respective terminal ends, a: cord 140; boot 150; and connector 160. The cord 140 (shown truncated in FIG. 1 for brevity) comprises, at least, a communication media (e.g. an electrical conductor and/or optical fiber) for carrying telecommunications signals and a sheath enshrouding the communication media. The cord extends up to, and is connected to, the connector 160. The boot 150 is located adjacent the connector 160, away from which the boot tapers, and surrounds a portion of the cord 140. The boot is provided for mechanical support so as to limit flexing at the junction between the cord and the connector, where cables are otherwise susceptible to damage from strain. The connector 160 is the interface terminal for each cable 110, and is configured for mechanical and communicative interconnection (electrically and/or optically, as appropriate depending on the communication media of the cord) with a corresponding connector.

The housing 120 provides a space within which the pair of interconnected telecommunications cables 110 are available to be fixedly stored by means of the engagement formation 130.

As shown in FIG. 1, the housing 120 comprises a plurality of (three) engagement formations 130. As described in more detail below, each engagement formation 130 is available to receive, and to fasten to the housing, the pair of interconnected telecommunications cables 110, thereby to help retain cables in position in an interconnected state.

Each engagement formation 130 comprises a pair of opposing walls that define an open channel 170; this channel is dimensioned (by the channel having an appropriate depth and width) so as to receive the interconnected telecommunications cables 110, and specifically the entirety (at least in two dimensions) of each connector 160 and boot 150, as well as a portion of each cord 140.

Furthermore, the channel 170 is dimensioned so as to retain the interconnected telecommunications cables 110 by closely matching the dimensions of the channel to the dimensions of the interconnected telecommunications cables 110, such that the interconnected telecommunications cables, when placed within the channel 170, abut against the walls of the channel, thereby limiting movement of the interconnected telecommunications cables. Accordingly, the engagement formation 130 substantially conforms with the shape and dimensions of the connector 160, boot 150 and cord 140. In particular, by appropriately dimensioning the channel 170, the channel is available to provide a friction fit engagement for the interconnected telecommunications cables 110.

In the example shown in FIG. 1, the shape and dimensions of the connector 160, boot 150 and cord 140 differ from one another, at least in that the width of the connector is greater than that of the boot, which in turn has a greater width than the cord. Accordingly, the engagement formation 130 is provided with differently-shaped and -dimensioned portions, namely a: cord engagement member 130-1; boot engagement member 130-2; and connector engagement member 130-3.

The connector engagement member 130-3 is dimensioned so as to receive and retain both connectors 160 when interconnected.

In turn, the boot engagement member 130-2, which extends from either side of the connector engagement member 130-3, is dimensioned so conform with the shape and dimension of the boot, thereby to receive and retain each boot 150. As a result, the channel 170 formed by the boot engagement member 130-2 comprises tapers that narrow, away from the connector engagement member 130-3, thereby forming throats in the channel at the ends of the boot engagement member 130-2 that are arranged distally to the connected engagement member 130-3.

Due to these throats in the channel 170, the boot engagement member 130-2 is available to limit travel of the pair of interconnected telecommunications cables 110 when a tugging force is applied to the cables 110, thereby preventing the cables from slipping through the enclosure and preventing their disconnection.

Correspondingly, the cord engagement member 130-1, which extends from (in both opposing direction) the boot engagement member 130-2, distally from the connector engagement member 130-2, is shaped and dimensioned substantially the same as the cords 140, thereby to receive and retain a portion (equal to the length of the cord engagement member 130-1) of each cord 140.

In this way, the engagement formation effectively conforms with the shape and dimensions of the various portions of the terminal ends of the pair of interconnected telecommunications cables 110.

The boot engagement member 130-2 extends in prolongation from (in both opposing directions) the connector engagement member 130-3, and in turn the cord engagement member 130-1 extends in prolongation away from the boot engagement member 130-2. In this way, the engagement formation 130 is available to provide distributed support along the connectors 160, boots 150 and cords 140 when strain is applied upon the pair of interconnected telecommunications cables 110.

The channel 170 is straight, thereby to align the pair of interconnected telecommunications cables.

For material and space efficiency, at least a portion of the structures of the plurality of engagement formations 130 are shared between adjacent engagement formations. In particular, as shown FIG. 1, the connector engagement member 130-3 of one engagement formation also forms the connector engagement member of another, adjoining, engagement formation.

The housing 120 is formed of a base 170-1 and lid 170-2, which are coupled together by means of a hinge 124 and which are actuatable between an open position (as shown in FIG. 1) and a closed position (not shown). In the closed position, the lid and the base enclose a space within which the pair of interconnected telecommunications cables 110 are stored.

In order further to limit freedom of the pair of interconnected telecommunications cables 110, a plurality of further engagement formations 180 is provided on the lid 170-2, which substantially corresponds to, and are aligned with, the engagement formations 130 provided on the base 170-1. In this way, when the housing 120 is in the closed position, the pair of interconnected telecommunications cables is enclosed, and therefore fastened, by both corresponding engagement formations 130, 180.

The housing further comprises a locking mechanism 190 arranged distally to the hinge 200. The housing it therefore available to be locked in a closed position by means of the locking mechanism 190.

The engagement formations 130 are provided as part of the housing 120, and are available to be integrally formed together.

The housing 120 further comprises an aperture (not shown in FIG. 1), or set of apertures, through which the cords 140 are available to extend outside of the housing.

In a specific example, the pair of interconnected telecommunications cables 110 are each in the form of fiber optic cables, and specifically Multi-fiber Push-On (MPO) cables.

### ALTERNATIVES AND MODIFICATIONS

It will be appreciated that any number of engagement formations may be provided as part of the housing, and therefore the enclosure is suitable for storing any such number of pairs of interconnected telecommunications cables.

In the above, the engagement formation is shown as a continuous channel formed by continuous walls of the engagement formation. In an alternative, the engagement formation is instead formed as a series of protrusions (such as in a castellated arrangement) that define a series of aligned channels.

In one example, the plurality of engagement formations comprise differently-shaped and/or dimensioned engagement formations, thereby to be able to store different types of interconnected telecommunications cables (each of which may have their own shape and dimensions).

Furthermore, although each engagement formation is shown as supporting interconnected cables of the same type (and therefore the engagement formation is symmetrical), it will be appreciated that the engagement formation is available to be configured (by appropriate dimensioning and shaping) to retain two interconnected cables of different kinds.

In an alternative, the engagement formation 130 is provided without the cord engagement member 130-1.

In one example, no hinge 200 is provided as part of the enclosure. Instead, the bodies 122 are available to be provided separately and uncoupled, or absent the lid 170-2 entirely (which is especially appropriate where the base is configured for fixing to a wall).

In yet another alternative, where a lid 170-2 is provided, the engagement formations 130 are provided solely on the base or the lid.

In an alternative, the housing 120 comprises a mounting member for mounting to a surface.

In an alternative, the walls of the channel 170 are formed of, or internally lined with, a compliant material so as to receive the pair of interconnected telecommunications cables 110 and to retain the cables by compression.

In one example, each, or a, connector 160 is available to comprise a uniter, which is in turn available to be accommodated by the connector engagement member 130-3

Each feature disclosed herein, and (where appropriate) as part of the claims and drawings may be provided independently or in any appropriate combination.

Any reference numerals appearing in the claims are for illustration only and shall not limit the scope of the claims.

1. An enclosure for a pair of interconnected telecommunications cables, each telecommunication cable of the pair of interconnected telecommunications cables comprising a connector and a boot, and the enclosure comprising:
a housing for the pair of interconnected telecommunications cables; and
an engagement formation configured to receive each connector and each boot of the pair of interconnected telecommunications cables and to fasten the telecommunications cables to the housing.

2. The enclosure according to claim 1, wherein the engagement formation comprises:
a boot engagement member for receiving each boot; and
a connector engagement formation for receiving each connector.

3. The enclosure according to claim 2, wherein the boot engagement member extends in prolongation of the connector engagement formation.

4. The enclosure according to claim 2, wherein the boot engagement member and the connector engagement formation are aligned with one another.

5. The enclosure according to claim 1, wherein the engagement formation is provided as part of the housing.

6. The enclosure according to claim 5, wherein the engagement member is integrally formed with the housing.

7. The enclosure according to claim 1, wherein the engagement formation is shaped and dimensioned so as to conform with shapes and dimensions of each of the connectors and the boots.

8. The enclosure according to claim 1, wherein the engagement formation comprises a channel.

9. The enclosure according to claim 1, wherein the engagement formation comprises a surface for preventing disconnection of the pair of interconnected telecommunications cables when the telecommunications cables are provided in the engagement formation.

10. The enclosure according to claim 1, wherein the housing comprises a complementary lid and a base, wherein the engagement formation is formed of a first part arranged on the lid and a second part arranged on the base.

11. The enclosure according to claim 1, wherein the pair of interconnected telecommunications cables each comprise a cord extending from the boot, and wherein the engagement formation is further configured to receive and to fasten the cord.

12. The enclosure according to claim 1, wherein the engagement formation is in the form of at least one of a friction-fit engagement and/or or a compression-fit engagement for the pair of interconnected telecommunications cables.

13. The enclosure according to claim 1, wherein the engagement formation extends along an entire length of the housing.

14. The enclosure according to claim 1, comprising a plurality of engagement formations, thereby to fasten a plurality of pairs of interconnected telecommunications cables to the housing.

15. The enclosure according to claim 14, wherein at least a portion of a given engagement formation of the plurality of engagement formations also forms at least a portion of another engagement formation that is adjacent to the given engagement formation of the plurality of engagement formations.

16. The enclosure according to claim 14, wherein the plurality of engagement formations are arranged parallel to one another.

17. The enclosure according to any of claim 14, wherein the plurality of engagement formations lie in the same plane.
